(19) United States
(12) Patent Application Publication
(10) Pub. No.: US 2008/0155345 A1
(43) Pub. Date: Jun. 26, 2008

(54) APPARATUS AND METHOD FOR FORMING A BUS TRANSACTION TRACE STREAM WITH SIMPLIFIED BUS TRANSACTION DESCRIPTORS

(75) Inventors: Ernest L. EDGAR, Larkspur, CO (US); Bruce ABLEIDINGER, Portland, OR (US); Neal S. STOLLON, Dallas, TX (US)

Correspondence Address: COOLEY GODWARD KRONISH LLP, ATTN: PATENT GROUP, 777 6TH STREET NW SUITE 1100, WASHINGTON, DC, 20001, US

(73) Assignee: MIPS TECHNOLOGIES, INC., Mountain View, CA (US)

(21) Appl. No.: 11/555,122

(22) Filed: Oct. 31, 2006

(51) Int. Cl. G06F 11/00

(52) U.S. Cl. 714/43; 714/45

(57) ABSTRACT

A method of monitoring bus transactions between masters and slaves includes generating simplified bus transaction descriptors to characterize bus transactions. Simplified bus transaction descriptors are consolidated to form a bus transaction trace stream. The bus transaction trace stream is routed to a probe.

### BRIEF DESCRIPTION OF THE INVENTION

This invention relates generally to digital systems. More particularly, this invention relates to forming a bus transaction trace stream for a master-slave system, where the bus transaction trace stream has simplified bus transaction descriptors.

### BACKGROUND OF THE INVENTION

Complex digital systems with multiple master devices (e.g., multi-purpose processors, digital signal processors, audio processors, video computation elements, or direct memory access controllers) commonly share bus resources. Such systems can exhibit poor performance related to bus utilization and bus master priority issues. In such systems, the bus is formed within a single chip and therefore the bus is not visible to a traditional external logic analyzer. An internal logic analyzer may be used to visualize bus traffic so that the system can be tuned for optimal performance. Implementing an internal logic analyzer is not practical in view of the large amount of data to be processed and limited silicon area. While comprehensive bus data can be routed off-chip for processing, such an approach still leads to information processing challenges.

Thus, it would be desirable to develop a technique for efficiently processing bus data associated with a complex digital system with multiple master devices.

### SUMMARY OF THE INVENTION

The invention includes a method of monitoring bus transactions between masters and slaves. Simplified bus transaction descriptors are generated to characterize bus transactions. Simplified bus transaction descriptors are consolidated to form a bus transaction trace stream. The bus transaction trace stream is routed to a probe.

The invention also includes a system with a bus and bus agents connected to the bus, Each bus agent generates simplified bus transaction descriptors characterizing bus traffic. A funnel consolidates the simplified bus transaction descriptors from the bus agents to form a bus transaction trace stream.

The invention also includes a computer readable storage medium with executable instructions to characterize a bus and bus agents connected to the bus. Each bus agent generates simplified bus transaction descriptors characterizing bus traffic. A funnel consolidates the simplified bus transaction descriptors from the bus agents to form a bus transaction trace stream.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates processing operations associated with an embodiment of the invention.

FIG. 3 illustrates a master-slave system configured in accordance with an embodiment of the invention.

FIG. 4 illustrates a funnel configured in accordance with an embodiment of the invention.

FIG. 5 illustrates a funnel configured in accordance with another embodiment of the invention.

FIG. 6 illustrates unfiltered bus activity data formed in accordance with an embodiment of the invention.

FIG. 7 illustrates bus activity data with graphical indicia to distinguish activity associated with selected master devices displayed in accordance with an embodiment of the invention.

FIG. 8 illustrates bus activity data with filtered data characterizing a subset of bus activity displayed in accordance with an embodiment of the invention.

FIG. 9 illustrates bus activity data with time differential data displayed in accordance with an embodiment of the invention.

Like reference numerals refer to corresponding parts throughout the several views of the drawings.

### DETAILED DESCRIPTION OF THE INVENTION

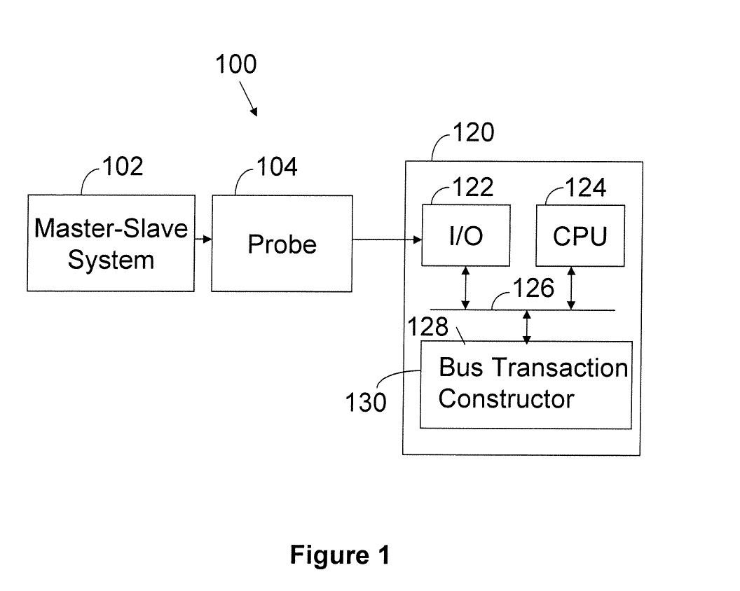

FIG. 1 illustrates a system 100 configured in accordance with an embodiment of the invention. The system 100 includes a master-slave system 102, which generates simplified bus transaction descriptors, which are consolidated to form a bus transaction trace stream. The simplified bus transaction descriptors operate to compress information about bus activity within the system 102. The bus transaction trace stream is then routed to a probe 104, which may be configured to time stamp bus transaction descriptors of the bus transaction trace stream. The bus transaction trace stream is then routed to an external device, such as a computer 120.

The computer 120 includes standard components such as a set of input/output devices 122. The input/output devices 122 may include a probe port, a keyboard, mouse, display, printer, and the like. The input/output devices 122 are connected to a central processing unit 124 via a bus 126. A memory 128 is also connected to the bus 126. The memory 128 includes a bus transaction constructor 130, which includes executable instructions to process the bus transaction trace stream and thereby reconstruct bus activity within the system 102. Standard techniques may be used to reconstruct the bus activity. These standard techniques are facilitated by the compressed and efficient nature of the information within the bus transaction trace stream. In other words, because the system 102 efficiently processes and condenses bus activity information, the process of reconstructing bus traffic is simplified. The reconstructed bus activity may be presented on a display associated with the input/output devices 122. The reconstructed bus activity allows for the visualization of bus traffic in a complex digital system, which facilitates debugging and tuning of the complex digital system.

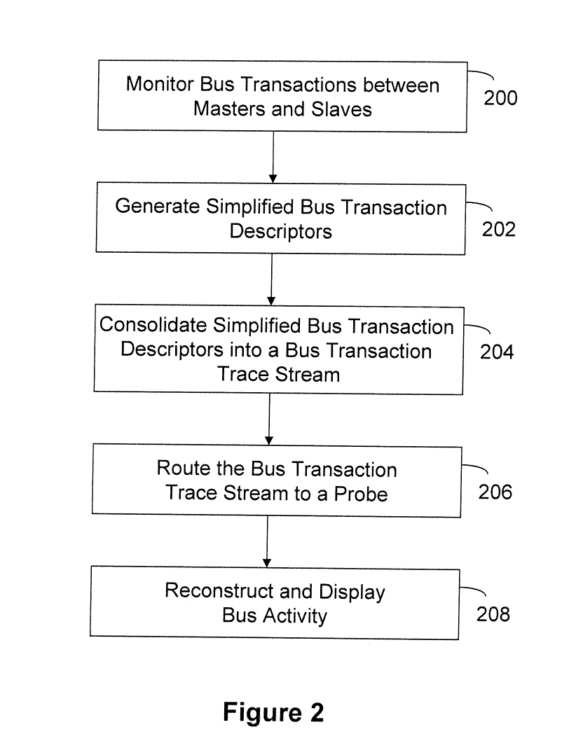

FIG. 2 illustrates processing operations associated with an embodiment of the invention. Bus transactions between masters and slaves are monitored 200. In particular, bus agents of the invention are inserted into selected locations within the system 102 to monitor bus transactions Simplified bus transaction descriptors are then generated 202. The simplified bus transaction descriptors are generated by the bus agents, which monitor bus traffic and condense information associated with the bus traffic to form the simplified bus transaction descriptors. As discussed below, the simplified bus transaction descriptors for each agent are in a standard format. The standard format operates to insulate downstream processing units from the complexities associated with bus traffic at each bus agent.

The simplified bus transaction descriptors are then consolidated into a bus transaction trace stream 204. As discussed below, a circuit, referred to herein as a funnel, is used to combine the bus transaction descriptors into a bus transaction trace stream. The bus transaction trace stream is then routed to a probe 206. The probe (e.g., probe 104 of FIG. 1) then routes the bus transaction trace stream to a computation device (e.g., computer 120 of FIG. 1), which reconstructs and displays the bus activity 208. Examples of the reconstructed and displayed bus activity are provided below.

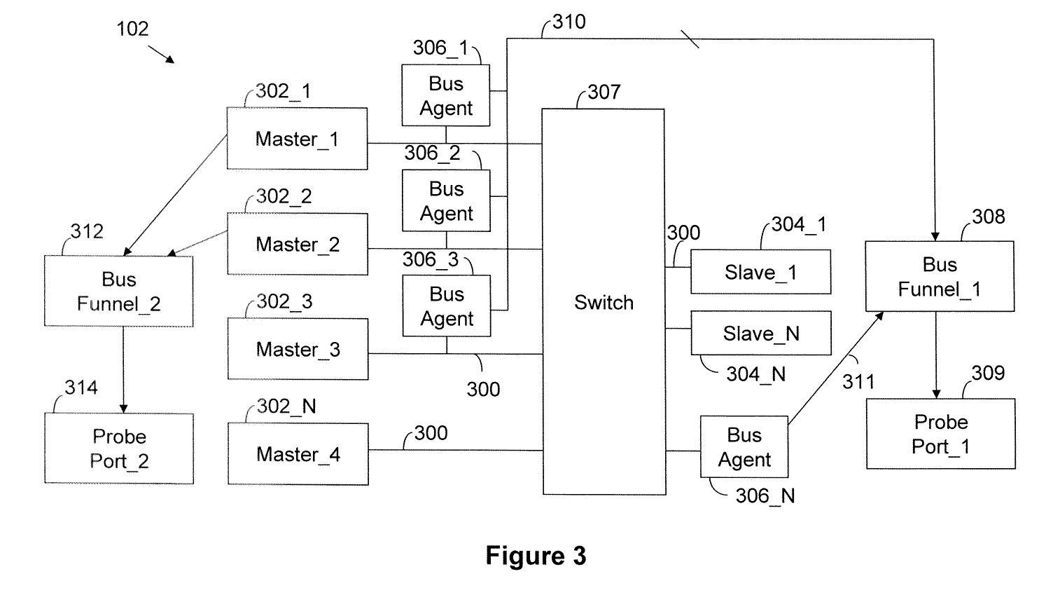

FIG. 3 is an exemplary master-slave system 102. The master-slave system includes bus segments 300 (collectively referred to as a bus) linking components of the system 102. Master devices, such as master devices 302_1 through 302_N may include multi-purpose processors, digital signal processors, audio processors, video computation elements, direct memory access controllers, and the like. The master devices interact with slave devices, such as slave devices 304_1 through 304_N. A switch 307 may be used to facilitate these interactions. The slave devices 304 may include various memory blocks and various peripherals. Bus agents 306_1 through 306_N are positioned at various locations within the system 102. Each bus agent generates simplified bus transaction descriptors and routes them to a circuit, such as bus funnel_1 308. In the example of FIG. 3, bus agent leads 310 route simplified bus transaction descriptors from bus agents 306_1, 306_2 and 306_3 to bus funnel_1 308. A separate line, such as line 311, may be used to route simplified bus transaction descriptors from another bus agent, such as bus agent 306_N. The bus funnel 308 consolidates the simplified bus transaction descriptors into a bus transaction stream, which is routed to a probe port, such as probe port_1 309.

In one embodiment of the invention, information is directly routed from one or more master devices (e.g., 302_1 and 302_2) to a second circuit, such as bus funnel_2 312. The second bus funnel 312 routes a second bus transaction trace stream to a second probe port 314. This pathway and funnel may be used to support known tracing operations, as discussed below. The known tracing operations may be used to supplement the information generated using the techniques of the invention.

Attention now turns to a discussion of a specific embodiment of the invention that is compatible with systems sold by MIPS Technologies, Inc., Mountain View, Calif. In particular, attention turns to a discussion of a bus agent that may be used in connection with a MIPS 34K processor, In one embodiment, up to two requests and two responses may occur in a bus clock cycle. Therefore the bus agent includes two request messages and two response messages, designated A and B, with A being the messages from the earlier of the two CPU cycles. In one embodiment, the bus agent uses both a processor clock (to time data sampling from the bus) and the bus clock (to transmit results to a funnel). The agent does not format a trace message, but instead passes enough information to the funnel to allow the funnel to formulate a trace message. All agent outputs are registered using the bus clock rising edge. In one embodiment of the invention, request phase signals from an agent to a funnel adhere to the following format.

| | Width | |
|---|---|---|
| Signal Name | in Bits | Comment |
| MAddr[N:2] | configurable | Enough bits to uniquely identify the |
| | | slave and offset within the slave. |
| | | MAddr[1:0] are fixed at zero. |
| | | MAddr[2] is computed |
| | | from byte enables. |
| MCmdAccept[1:0] | 2 | 00=IDLE, 01=WR, 10=RD, |
| | | others=not used. |
| | | MCmdAccept = MCmd & |
| | | SCmdAccept. |
| MTagID[3:0] | 4 | Identifies which read buffer is |
| | | being requested |
| MBurstLength[0] | 1 | 1=single, 0=4-beat burst |

Observe that the agent operates to compress an address and offset to the number of bits needed to uniquely identify a slave and an offset into the slave. The burst length signal is another example of compression, by specifying a burst length and ignoring the data associated with the burst, a great deal of information may be omitted from subsequent processing.

In one embodiment, response phase signals adhere to the following format.

| Signal Name | Width in Bits | Comment |
|---|---|---|
| SResp[1:0] | 2 | Identifies read data transfer |
| | | (IDLE, DVA, or ERR) |
| SRespLast | 1 | Last read data transfer in a burst |
| STagID[3:0] | 4 | Identifies which request this response |
| | | is for |

### In this example, a compact 7 bit signal is sufficient to characterize response information.

The foregoing example relates to a bus agent processing information associated with a master device in the form of a processor. Bus agents may also be configured for other types of master devices, such as a video computation element. For example, assume that master device 302_N is a video computation element attached to switch 307. Bus agent 306_N is connected to the master device 302_N via the switch 307. In this example, one request and one response may occur in any bus clock cycle. Therefore, the bus agent 306_N includes one request message and one response message leading to the funnel 308. The bus agent 306_N does not format a trace message, but instead passes enough information to the funnel 308 to allow the funnel 308 to formulate a trace message. All bus agent outputs are registered using the bus clock rising edge. The request and response phase signals are the similar to the bus agent of the previous example except that the MTagID and STagID fields are replaced with a separate field, MConnID[2:0], which indicates the video computation element number (0 to 6). In this example, the request phase signals from the agent to the funnel may observe the following format.

| | Width | |
|---|---|---|
| Signal Name | in Bits | Comment |
| MAddr[N:2] | configurable | Enough bits to uniquely identify the |
| | | slave and offset within the slave. |
| | | MAddr[1:0] are fixed at zero. |
| | | MAddr[2] is |
| | | computed from byte enables. |
| MCmdAccept[1:0] | 2 | 00=IDLE, 01=WR, 10=RD, |
| | | others=not used. |
| | | MCmdAccept = MCmd & |
| | | SCmdAccept. |
| MConnID[2:0] | 3 | Identifies which VPE generates |
| | | the request |
| MBurstLength[2:0] | 3 | Burst size |

In this example, the response phase signals have the following format.

| Signal Name | Width in Bits | Comment |
|---|---|---|
| SResp[1:0] | 2 | Identifies read data transfer (IDLE, DVA, |
| | | or ERR) |
| SRespLast | 1 | Last read data transfer in a burst |

A different type of agent may be used in connection with direct memory access controllers. For example, a 16-channel direct memory access unit uses a single bus to connect to the switch 307. In this example, the bus associated with the direct memory access unit does not use split or retry signals, and out-of-order responses cannot occur. Therefore, the information required to associate a response with its corresponding request is simpler than in the previous examples. One request and one response can occur in each bus clock cycle. Therefore, in this example, request phase signals from an agent to a funnel may be configured as follows.

| | Width | |
|---|---|---|
| Signal Name | in Bits | Comment |
| HADDR[N:2] | configurable | Enough bits to uniquely identify the slave |
| | | and offset within the slave. HADDR[1:0] |
| | | are fixed at zero. |
| HTRANS[1:0] | 2 | IDLE, BUSY, NONSEQ, SEQ |
| HWRITE | 1 | 1=write, 0=read |
| HBURST[2:0] | 3 | Length of burst |

Response phase signals in this example may be configured as follows.

| Signal Name | Width in Bits | Comment |
|---|---|---|
| HREADY | 1 | Identifies data transfer |
| HRESP[0] | 1 | OKAY or ERROR |

Observe that bus agents of the invention may be configured in different ways depending upon their location within the system. Thus, each bus agent may be optimized for the particular set of traffic that it must handle. Consequently, a funnel need not accommodate the complexities of different bus traffic flows within the system. Rather, the bus agents insulate the funnels from this complexity.

In one embodiment, the bus funnel 308 accepts simplified bus transaction descriptors from each agent at the bus clock rate, The simplified bus transaction descriptors are concatenated to form a trace frame or bus transaction trace stream

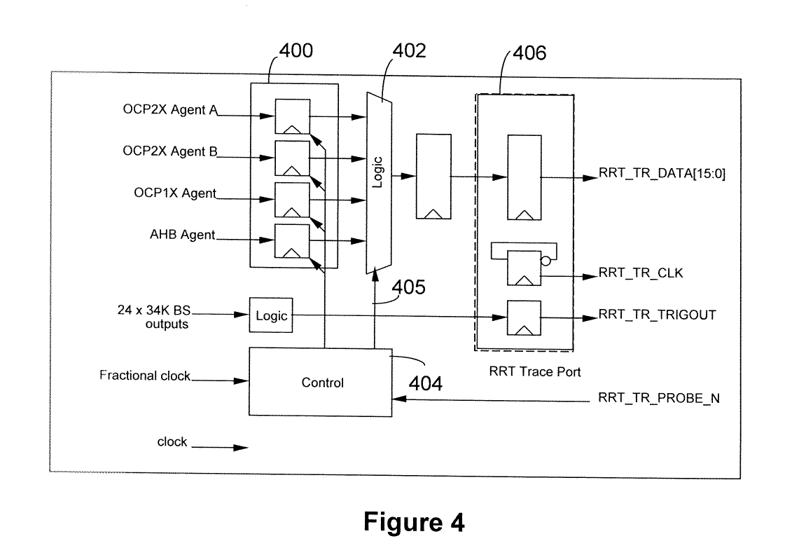

FIG. 4 illustrates a funnel (e.g., 308) configured in accordance with an embodiment of the invention. A set of registers 400 receive data from various bus agents, including an agent associated with a first processor (OCP2X Agent A), an agent associated with a second processor (OCP2X Agent B) an agent associated with a video control element (OCP1X), and an agent associated with a direct memory access controller (AHB). The simplified bus transaction descriptors associated with each of these agents are consolidated via logic 402. In one embodiment, the logic 402 is a configurable multiplexer. A register associated with the control circuit 404 specifies the size of the multiplexer. Standard software techniques may be used to write a configuration size to the register. The configuration size is used to generate select signals on multiplexer select bus 405. A trace port 406 processes the bus transaction trace stream from the logic 402. In particular, the trace port 406 outputs a data signal (RRT_TR_DATA[15:0]), a clock signal (RRT_TR_CLK) and a trigger signal (RRT_TR_TRIGOUT).

The trace frame may or may not include inputs from a particular agent. User selections affect the trace frame format. In one embodiment, both the funnel and the receiver in the probe are configured according to user selections so that they agree on the trace frame format without that information needing to be present in the data itself. In one embodiment, every enabled agent's trace message is included in every trace frame whether or not there is an active request or response in a particular cycle.

If the fractional bus clock is configured slower than necessary to transmit an entire trace frame in each bus clock, there are idle cycles present on the trace port outputs between frames. In one embodiment, the first 16-bit slice of each trace frame includes at least one non-zero bit, marking the first slice of a frame transmission. The receiver knows, based on the user setup, how many slices to expect in the trace frame. Once the entire frame is completed, the trace port outputs zeroes and the receiver waits for the next valid bit to start receiving the next frame.

If the fractional bus clock is configured too fast, the funnel does not have time to transmit an entire frame before the next frame arrives. This is a system setup error that can be detected and flagged prior to starting a trace session.

Trace messages are generated from each agent's outputs. A message includes both the request and the response that occur in a particular cycle. Trace formats for different agents may be different

For example, the trace message for an agent associated with a processor may be as follows.

| Field | Width | | Bitfield | Comment |
|---|---|---|---|---|
| SlaveID | 3 | | 2:0 | Request phase, Slave ID |
| | | | | 000=no request, others=encodes |
| | | | | up to 7 slaves |
| Write | 1 | | 3 | Request phase, 1=Write, 0=Read. |
| | | | | 1 if SlaveID=000. |
| BurstLength | 1 | | 4 | Request phase, 1=single word, |
| | | | | 0=4 words |
| | 1 | | 5 | zero |
| MTagID | 4 | | 9:6 | Request phase, transaction identifier |
| | | | | tag |
| STagID | 4 | | 13:10 | Response phase, transaction |
| | | | | identifier tag |
| SResp | 2 | | 15:14 | Response phase, Idle, DVA, ERR |
| Total | 16 | bits | | |

Note that the MasterID is not needed because the probe knows which master it is by the position in the trace frame. In full mode, an additional set of 24 request phase address bits are recorded. A2 is the lowest address bit recorded. A1:A0 are assumed to be zero.

| Field | Width | Bitfield | Comment |
|---|---|---|---|
| MAddr[25:2] | 24 | 39:16 | |

The Slave ID field is computed by the funnel in the same way for all three types of agents discussed herein. The computation is done using a lookup table based on masked comparisons of address bits 30 down to 15. In the present embodiment, up to 7 slaves may be configured by the user or automatic configuration file. A SlaveID of zero indicates that there is no request in this cycle. Values and masks for the comparison are stored in registers accessible through a funnel JTAG port if provided,

In combination with the SlaveID, the MAddr field can identify the peripheral and offset within that peripheral that is being accessed, assuming the maximum size of any one slave is 2̂26 (64M) bytes. In one embodiment, the lookup algorithm is a priority encoder with the following function.

if (((addr[30:15] \hat{ } RRTSlave_value1) & RRTSlave_mask1) == 0)
slaveID = 1;
else if (((addr[30:15] \hat{ } RRTSlave_value2) & RRTSlave_mask2) == 0)
slaveID = 2;
. . .
else if (((addr[30:15] \hat{ } RRTSlave_value6) & RRTSlave_mask6) == 0)
slaveID = 6;
else slaveID = 7;

The trace message format for a video computation element is similar to that of the previously described processor trace message format. However, the tag bits have different meaning—they identify the specific video computation element rather than a processor read buffer. The video computation element agent trace message format may be configured as follows.

| Field | Width | | Bitfield | Comment |
|---|---|---|---|---|
| SlaveID | 3 | | 2:0 | Request phase, Slave ID |
| | | | | 000=no request, others=encodes up |
| | | | | to 7 slaves |
| Write | 1 | | 3 | Request phase, 1=Write, 0=Read. 1 if |
| | | | | SlaveID=000. |
| BurstLength | 3 | | 6:4 | Request phase, burst length |
| MConnID | 3 | | 9:7 | Request phase, VCE number |
| RespOrder | 4 | | 13:10 | Response phase. Which Request |
| | | | | matches this response |
| SResp | 2 | | 15:14 | Response phase, Idle, DVA, ERR |
| Total | 16 | bits | | |

Note that the MasterID is not needed because the probe knows that it is the video computation element (VCE) bus by the position in the trace frame. Which VCE generated the request is encoded in the MConnID bits The funnel maintains a counter of the number of outstanding transactions that have been requested Each response message includes that counter value so that the response can be associated with its corresponding request. The RespOrder field varies from 0 to 14 to indicate the first through 15th preceding requests. A RespOrder value of 15 indicates that the corresponding request is 16 or more requests earlier.

The trace message format for a direct memory access agent is slightly different than the previous embodiments. The direct memory access agent is capable of more burst lengths, requiring a 3-bit BurstLength field, but does not allow overlapping or out-of-order cycles, so no tag fields are needed in the response. The trace message format may be configured as follows.

| Field | Width | | Bitfield | Comment |
|---|---|---|---|---|
| SlaveID | 3 | | 2:0 | Request phase, Slave ID |
| | | | | 000=no request, others=encodes up |
| | | | | to 7 slaves |
| Write | 1 | | 3 | Request phase, 1=Write, 0=Read. 1 |
| | | | | if SlaveID=000. |
| BurstLength | 3 | | 6:4 | Request phase, burst length (same |
| | | | | coding as HBURST) |
| Channel | 4 | | 10:7 | Channel number of DMA for |
| | | | | this request |
| | | | 13:11 | zero |
| ResponseCode | 2 | | 15:14 | Response phase, IDLE, OKAY, |
| | | | | ERROR |
| Total | 16 | bits | | |

Attention now turns to format issues associated with a trace frame or bus transaction trace stream. In one embodiment, a trace frame may be between 16 and 240 bits, depending on user configuration. In one embodiment, the trace frame begins with 16 or 40 bits from a processor agent A phase 1 (if enabled), then proceeds with 16 or 40 bits each from processor agent A2, processor agent B1, processor agent B2, the video control element agent, and the direct memory access agent. Any combination of agents may be enabled, though A1/A2 and B1/B2 are enabled in pairs.

One possible trace frame is:

| | | | | | | | | | | | |
|---|---|---|---|---|---|---|---|---|---|---|---|
| 239 | 200 | 199 | 160 | 159 | 120 | 119 | 80 | 79 | 40 | 39 | 0 |

| | | | | | |
|---|---|---|---|---|---|
| DMA Agent | VCE Agent | Processor | Processor | Proc- | Proc- |
| | | Agent B2 | Agent B1 | essor | essor |
| | | | | Agent | Agent |
| | | | | A2 | A1 |

The trace funnel outputs a trace frame in 16-bit slices starting at the least significant enabled trace message. This slice is routed to the trace port (or probe port 310), which re-clocks and outputs it. Time between valid trace frames is filled with zeroes. At least one of the least significant 4 bits of the first enabled trace message is always non-zero, allowing the trace port receiver to identify the first slice of a trace frame.

The trace or probe port receives the 16-bit trace frame slice output and simply re-clocks it. In one embodiment, the trace port is put into a separate module so that it can be easily located close to I/O pads of the chip. In one embodiment, the trace port probe interface ports are intended to connect to chip pins and are shown in the following table.

| Signal Name | Source | Comment |
|---|---|---|
| RRT_TR_PROBE_N | System | Probe will assert this low. Funnel will stop its internal |
| | | clocks for power reduction when this signal is high. |
| | | Typically, this would be pulled up on a board-level |
| | | design with a resistor. RRT_TR_CLK runs continuously |
| | | as long as RRT_TR_PROBE_N is asserted. |
| RRT_TR_CLK | Funnel | Double-data rate clock to probe |
| RRT_TR_DATA[15:0] | Funnel | Trace data to probe. |
| RRT_TR_TRIGOUT | Funnel | Single cycle trigger output to probe. Masked logical OR |
| | | of breakpoint status signals from two 34K's |

RRT_TR_CLK and RRT_TR_DATA[15:0] are each driven directly from registers. Skew control between RRT_TR_CLK and each of the signals in RRT_TR_DATA is critical for accurate transmission to a probe. RRT_TR_CLK and RRT_TR_DATA transition simultaneously and the probe is expected to create a reception sampling clock by doubling and phase shifting RRT_TR_CLK in order to latch RRT_TR_DATA at approximately the center of its valid zone. Routing of RT_TR_CLK and RRT_TR_DATA must meet impedance and maximum skew specifications associated with the MIPS 34K Integrator's Guide, section 4.4.5. These specifications affect both on-chip logic and the board layout.

In one embodiment, the trace port Connector is a 38-pin AMP Mictor connector, part number 2-0767004-2 or equivalent, the same connector used by some high-speed logic analyzer probes. Pinout, signal definition, and timing of the connector follow.

| Pin no. | Signal | Pin no. | Signal |
|---|---|---|---|
| 1 | NC | 2 | NC |
| 3 | RRT_TR_PROBE_N | 4 | VIO |
| 5 | RRT_TR_CLK | 6 | RRT_TR_CLK |
| 7 | RRT_TR_DATA[15] | 8 | NC |
| 9 | RRT_TR_DATA[14] | 10 | NC |
| 11 | RRT_TR_DATA[13] | 12 | NC |
| 13 | RRT_TR_DATA[12] | 14 | NC |
| 15 | RRT_TR_DATA[11] | 16 | NC |
| 17 | RRT_TR_DATA[10] | 18 | NC |
| 19 | RRT_TR_DATA[9] | 20 | NC |
| 21 | RRT_TR_DATA[8] | 22 | NC |
| 23 | RRT_TR_DATA[7] | 24 | NC |
| 25 | RRT_TR_DATA[6] | 26 | NC |
| 27 | RRT_TR_DATA[5] | 28 | NC |
| 29 | RRT_TR_DATA[4] | 30 | NC |
| 31 | RRT_TR_DATA[3] | 32 | NC |
| 33 | RRT_TR_DATA[2] | 34 | NC |
| 35 | RRT_TR_DATA[1] | 36 | RRT_TR_TRIGOUT |
| 37 | RRT_TR_DATA[0] | 38 | NC |

In one embodiment, at least one funnel includes a JTAG TAP, which is placed on the JTAG chain of the device in a daisy chain with the 4 TAP's of two processors. The funnel TAP Instruction Register is 4 bits long. The TAP instructions are:

| TAP Instruction | Value | Comment |
|---|---|---|
| IDCODE | 4′b0010 | Selects the read-only IDCODE value |
| RRTCTRL | 4′b0100 | Selects the RRT Control register |
| RRTSLAVE1 | 4′b1001 | Select RRTSLAVE1 register |
| RRTSLAVE2 | 4′b1010 | Select RRTSLAVE2 register |
| RRTSLAVE3 | 4′b1011 | Select RRTSLAVE3 register |
| RRTSLAVE4 | 4′b1100 | Select RRTSLAVE4 register |
| RRTSLAVE5 | 4′b1101 | Select RRTSLAVE5 register |
| RRTSLAVE6 | 4′b1110 | Select RRTSLAVE6 register |
| BYPASS | 4′b1111 | Bypass register (required by JTAG) |

The IDCODE register is a fixed value of 0×465332DX, where X begins at 0 and is incremented for future versions. The RRTCTRL register is organized as follows.

| Field | Width | Bitfield | Comment |
|---|---|---|---|
| OCP2XA_enable | 1 | 0 | Enable OCP2X Agent A (34K) |
| OCP2XB_enable | 1 | 1 | Enable OCP2X Agent B (34K) |
| OCP1X_enable | 1 | 2 | Enable OCP1X Agent (VCE) |
| AHB_enable | 1 | 3 | Enable AHB Agent (DMA) |
| BurstLast | 1 | 4 | 0=Report response on first burst cycle, |
| | | | 1=report on last |
| FullMode | 1 | 5 | 0=Fast Mode, 1=Full Mode |
| Reserved | 2 | 7:6 | reserved |
| TriggerMask | 24 | 31:8 | Mask configuring which of the 24 breakpoint |
| | | | status outputs from the two 34K's generate the |
| | | | RRT_TR_TRIGOUT signal. A 1 indicates that |
| | | | the corresponding breakpoint status generates a |
| | | | trigger when asserted. All enabled breakpoint |
| | | | status signals are logically OR'ed to create the |
| | | | RRT Trigger. |
| | | | From MSB to LSB, TriggerMask is assigned as |
| | | | follows: |
| | | | B_SI_DBS_1[1:0] data bkpt, core B, VPE 1 |
| | | | B_SI_DBS[1:0] data bkpt, core B, VPE 0 |
| | | | B_SI_IBS_1[3:0] inst bkpt, core B, VPE 1 |
| | | | B_SI_IBS[3:0] inst bkpt, core B, VPE 0 |
| | | | A_SI_DBS_1[1:0] data bkpt, core A, VPE 1 |
| | | | A_SI_DBS[1:0] data bkpt, core A, VPE 0 |
| | | | A_SI_IBS_1[3:0] inst bkpt, core A, VPE 1 |
| | | | A_SI_IBS[3:0] inst bkpt, core A, VPE 0 |

The RRTSLAVE1 through RRTSLAVE6 registers are organized as follows:

| Field | Width | Bitfield | Comment |
|---|---|---|---|
| RRTSlave_value | 16 | 15:0 | Value portion of slave ID |
| | | | comparison on Maddr[30:15] |
| RRTSlave_mask | 16 | 31:16 | Mask portion of slave ID |
| | | | comparison on Maddr[30:15] |

As shown in FIG. 3, a second bus funnel 312 may be directly attached to selected processors, e.g., 302_1 and 302_2. In this embodiment, standardized trace information may supplement the previously described bus transaction trace stream. For example, each MIPS 34K processor includes a PDtrace™ module. The “TCTrace” interface defined in the MIPS 34K Integrator's Guide defines the connection protocol between the MIPS 34K processor and the PDtrace Funnel. Ordinarily, a MIPS PDtrace system includes a Probe Interface Block (PIEB) which comprises the off-chip registered interface to the trace port.

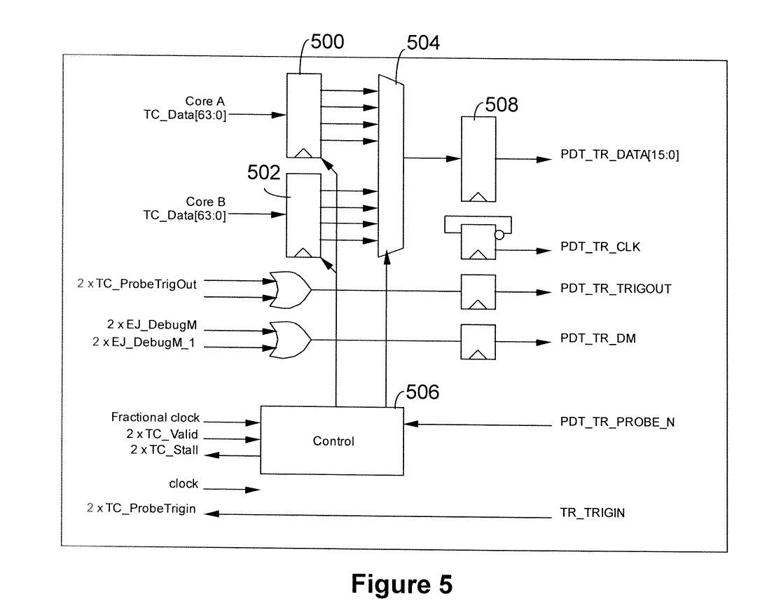

FIG. 5 illustrates a funnel (e.g., 312) associated with the proprietary MIPS PDTrace format. In this embodiment, register bank 500 receives a 64-bit signal from a first core (e.g., processor core 302_1) while register bank 502 receives a 64-bit signal from a second core (e.g., processor core 302_2). A multiplexer 504 routes 16-bit data signals to register 508 under the control of control circuit 506. The control circuit 506 is responsive to a fractional clock, a valid signal, a stall signal and a probe signal, as shown in FIG. 5.

The following table lists the TCTrace interface signals between each 34K Processor and the PDtrace Funnel (e.g., funnel 312).

| Signal Name | Source | Comment |
|---|---|---|
| TC_Valid | TCB | TC_Data is valid in this cycle |
| TC_Data[63:0] | TCB | Trace data word from TCB |
| TC_Calibrate | TCB | Funnel produces calibration pattern output |
| TC_Stall | Funnel | Stall TCB output until Funnel has room to accept it |
| TC_PibPresent | Funnel | Driven high by Funnel to enable TCTrace port. |
| TC_CRMax[2:0] | Funnel | Statically driven to 3′b100 to indicate 1:2 clock ratio. |
| TC_CRMin[2:0] | Funnel | Statically driven to 3′b100 to indicate 1:2 clock ratio. |
| TC_ProbeWidth[1:0] | Funnel | Statically driven to 2′b11 to indicate 64 bit width |
| TC_DataBits[2:0] | Funnel | Statically driven to 3′b100 to indicate 64 bit width |

In one embodiment, the fractional and full-speed clocks are provided by system logic and are not generated by the PIB. Therefore, the TC_ClockRatio[2:0] output from the TCB is ignored. TCB data always appears at the CPU clock rate and the funnel outputs trace to the trace bus at 333 MHz.

In operation, valid trace words from the TCB that contain data (indicated by lower bits not all zero) are latched from the TC_Data input into an internal 64-bit register. The register is clocked onto funnel outputs at the 333 MHz rate, requiring four cycles to complete transmission of each trace word, or eight cycles to complete one trace word from each processor. If valid data is present on both TCTrace buses, it is accepted alternately from the two buses.

TC_Stall is used to throttle the inputs but occurs only if the CPU clock rate is more than ⅛ of the 333 MHz PDtrace funnel clock. TC_Stall only affects data flow between the TCB and the Funnel. While TC_Stall is asserted trace words are held in the TCB and as long as the TCB's own internal FIFO does not fill, real-time CPU operation is not affected.

The funnel probe interface ports may be configured as follows.

| Signal Name | Source | Comment |
|---|---|---|
| PDT_TR_PROBE_N | System | Probe will assert this low. Funnel will stop its |
| | | internal clocks for power reduction when this signal |
| | | is high. Typically this would be pulled up on a |
| | | board-level design with a resistor. PDT_TR_CLK |
| | | runs continuously as long as PDT_TR_PROBE_N |
| | | is asserted. |
| PDT_TR_CLK | Funnel | Double-data rate clock to probe |
| PDT_TR_DATA[15:0] | Funnel | Trace data to probe. |
| PDT_TR_TRIGIN | System | Rising edge trigger input signal from probe. Drives |
| | | TC_ProbeTrigIn of both 34K cores. |
| PDT_TR_TRIGOUT | Funnel | Single cycle trigger output to probe. Logical OR of |
| | | TC_ProbeTrigOut from the two 34K cores. |
| PDT_TR_DM | Funnel | Logical OR of the four EJ_DebugM and |
| | | EJ_DebugM_1 signals |

PDT_TR_CLK and PDT_TR_DATA[15:0] are each driven directly from registers. Skew control between PDT_TR_CLK and each of the signals in PDT_TR_DATA is critical for accurate transmission to a probe. PDT_TR_CLK and PDT_TR_DATA transition simultaneously and the probe is expected to create a reception sampling clock by doubling and phase shifting PDT_TR_CLK in order to latch PDT_TR_DATA at approximately the center of its valid zone. Routing of PDT_TR_CLK and PDT_TR_DATA must meet impedance and maximum skew specifications listed in the MIPS 34K Integrator's Guide, section 4.4.5

In one embodiment, the trace port connector is a 38-pin AMP Mictor connector, part number 2-0767004-2 or equivalent, the same connector used by some high-speed logic analyzer probes.

| Pin no. | Signal | Pin no. | Signal |
|---|---|---|---|
| 1 | NC | 2 | NC |
| 3 | PDT_TR_PROBE_N | 4 | VIO |
| 5 | PDT_TR_CLK | 6 | PDT_TR_CLK |
| 7 | PDT_TR_DATA[15] | 8 | TCK |
| 9 | PDT_TR_DATA[14] | 10 | TMS |
| 11 | PDT_TR_DATA[13] | 12 | TDI |
| 13 | PDT_TR_DATA[12] | 14 | TDO |
| 15 | PDT_TR_DATA[11] | 16 | TRST* |
| 17 | PDT_TR_DATA[10] | 18 | RST* |
| 19 | PDT_TR_DATA[9] | 20 | DINT |
| 21 | PDT_TR_DATA[8] | 22 | PDT_TR_DM |
| 23 | PDT_TR_DATA[7] | 24 | NC |
| 25 | PDT_TR_DATA[6] | 26 | NC |
| 27 | PDT_TR_DATA[5] | 28 | NC |
| 29 | PDT_TR_DATA[4] | 30 | NC |
| 31 | PDT_TR_DATA[3] | 32 | NC |
| 33 | PDT_TR_DATA[2] | 34 | NC |
| 35 | PDT_TR_DATA[1] | 36 | PDT_TR_TRIGOUT |
| 37 | PDT_TR_DATA[0] | 38 | PDT_TR_TRIGIN |

As described in the MIPS 34K Integrator's Guide, VIO configures the probe for the logic level implemented on all other pins of this interface. VIO in the PDtrace and Mictor connectors should be the same voltage level.

In one embodiment the probe supports two simultaneous 16-bit trace ports with independent clocks along with ordinary JTAG and sideband signals The SP supports a 333 MHz data transmission speed.

Any number of probe configurations may be used in accordance with embodiments of the invention. The details of any such probe configuration are insignificant. However trace signal formats and timing stamping issues are noteworthy.

In one embodiment, PDtrace trace words are recorded into memory as they arrive from the system. As detailed in the PDtrace specification, a trace word consists of 4 tag bits indicating where the start of the first full message begins, 2 bits indicating which core generated the word, and 58 bits of trace messages. The two source bits in PDtrace trace words are either 00 or 01.

| | | | | | |
|---|---|---|---|---|---|
| 63 | 6 | 5 | 4 | 3 | 0 |

| | | |
|---|---|---|
| PDtrace ™ Trace Messages | Src | Type |

A bus transaction trace stream with simplified bus transaction descriptors has trace frames that may be longer or shorter than a 64-bit DRAM trace word. Probe hardware first compresses each trace frame by removing messages in which there is neither a valid request nor a valid response and adds a 6-bit format field to indicate which agents' messages remain in the trace frame. The resulting compressed trace frame may be between 22 bits (if there is one message) and 246 bits (all 6 messages valid in full mode). If no valid messages occur in a frame, then nothing is recorded in trace memory.

| | | | |
|---|---|---|---|
| 21 to 245 | 6 | 5 | 0 |

| | |
|---|---|
| Compressed RRT Trace Messages | Format |

Probe hardware concatenates compressed trace frames into trace words by appending a 2-bit source field with value 10 and a Type bitfield indicating where a frame begins. If a frame cannot fit in the remaining space in a trace word, the first portion of the frame is inserted and the remainder is put into the next trace word. A 244-bit compressed frame could take more than four words to record. If a trace frame begins somewhere in a trace word, the Type field indicates the nibble number (1 to 15) in the 58-bit data field where the fra me begins. Type is zero if a trace word contains only the continuation of a previous trace frame.

| | | | | | |
|---|---|---|---|---|---|
| 63 | 6 | 5 | 4 | 3 | 0 |

| | | |
|---|---|---|
| RRT Trace Frame(s) | 10 | Type |

Trace words from trace ports may be interleaved and recorded in the order they arrive at the probe. Along with the trace data, the probe records timing information of received trace words. This allows software to determine the time between a request and its corresponding response. The timestamp is created using the local 266 MHz probe DRAM timing clock and therefore has a 3.75 ns resolution.

Normally, the 8 upper bits of the DRAM word represent the timestamp and indicate 0 to 255 clocks of separation from a trace word to the preceding trace word.

| | | | | | | | |
|---|---|---|---|---|---|---|---|
| 71 | 64 | 63 | 6 | 5 | 4 | 3 | 0 |

| | | | |
|---|---|---|---|
| timestamp | Trace messages | Src | Type |

If there is more than 255 clocks of separation, a full trace word is inserted containing the spacing in clocks. The timestamp counter is 32 bits, which will accommodate a time period of about 16 seconds at 266 MHz. If the timestamp counter overflows (indicating that no valid frames are recorded for a 16-second period), a timestamp record is inserted containing a time value of all ones. A timestamp trace word has the following format:

| | | | | | | | | | |
|---|---|---|---|---|---|---|---|---|---|
| 71 | 64 | 63 | 38 | 37 | 6 | 5 | 4 | 3 | 0 |

| | | | | |
|---|---|---|---|---|
| 0 | 0 | 32-bit timestamp | 11 | 0001 |

In one embodiment, a triggering system is a multi-state event detector that controls the capture system and target operation. Event detectors compare incoming capture data on each clock to a set of previously specified patterns. Pattern matching includes don't-care, high, low, rising edge falling edge either edge, double high, double low, and steady. When a match is detected, that event “fires” and feeds into the trigger engine.

Events are defined to apply to one or more of the channels and only those channels are compared with the event settings. An event fires if any enabled event matches the preprogrammed setting. For example, one could set an event to fire when either processor (meaning any of the four associated channels) initiates a write cycle to a specified slave in single-cycle mode.

Events apply only to compressed trace data, not PDtrace trace data. PDtrace has separate event recognition hardware inside each processor core which can generate breakpoint status (BS) outputs which in turn can generate RRT_TR_TRIGOUT signal on the Mictor connector.

The trigger engine generates actions when a specified condition is true. The conditions are combinations of the following trigger engine inputs:
An event detector comparison.
A trigger counter/timer matches its terminal count.
A trigger input to the probe is asserted. These include RRT_TR_TRIGOUT, PDT_TR_TRIGOUT, PDT_TR_DM, and an external trigger input to the probe.
The trigger engine sequencer state is a particular value or in a particular range.

These conditions may be combined in any way (using and, or, and not operators). When a specified trigger condition occurs, one or more actions is generated.
Change the trigger engine sequencer state.
Control one or more trigger counter/timers (start, stop, increment, and/or clear).
Control the capture system (start, stop, collect one sample, clear the capture buffer).
Generate a trigger output signal from the probe. Signals available are PDT_TR_TRIGIN to PDtrace, DINT to PDtrace, and an external trigger output from the probe.
Trigger the analyzer (mark this sample in the capture buffer, collect a specified additional amount, then stop the trace system,.

The triggering system always begins in sequencer state 0. The user specifies whether the capture system and each trigger counter begins in the active or inactive state.

On each cycle, the trigger system simultaneously checks for each specified trigger condition and executes the actions corresponding to each active condition. In some cases, conflicting actions are generated and in this case, a priority is defined. For example, if trigger actions occur to both start and stop the capture engine, then the start action is executed.

The user specifies the trigger program using a GUI editor or a set of Tcl commands. The editor includes a method to graphically enter an event definition and construct an if/then/else style trigger program.

The bus transaction constructor 130 of FIG. 1 unloads the trace memory and decodes it. In the case of PDtrace information from the second bus funnel 312, standard PDtrace algorithms are used. The simplified bus transaction descriptors of the bus transaction trace stream are processed using standard bus traffic analysis techniques.

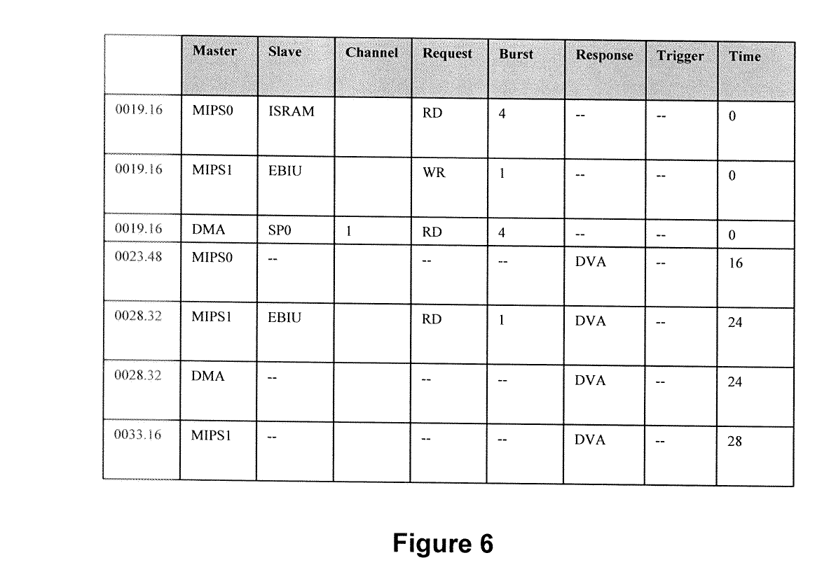

Various techniques may be used to display the resultant bus activity data. For example, the bus activity data may be displayed in a raw mode that shows all requests and responses occurring in each bus clock cycle. FIG. 6 illustrates bus activity data displayed in a raw mode. The bus activity data may include a master device name, a slave device name, a master channel identification (e.g., read buffer, video computation element number, direct memory access channel number, and the like), request type (e.g., none, read, write), burst size, response type (e.g., none, normal, error), trigger status, and time since previous cycle.

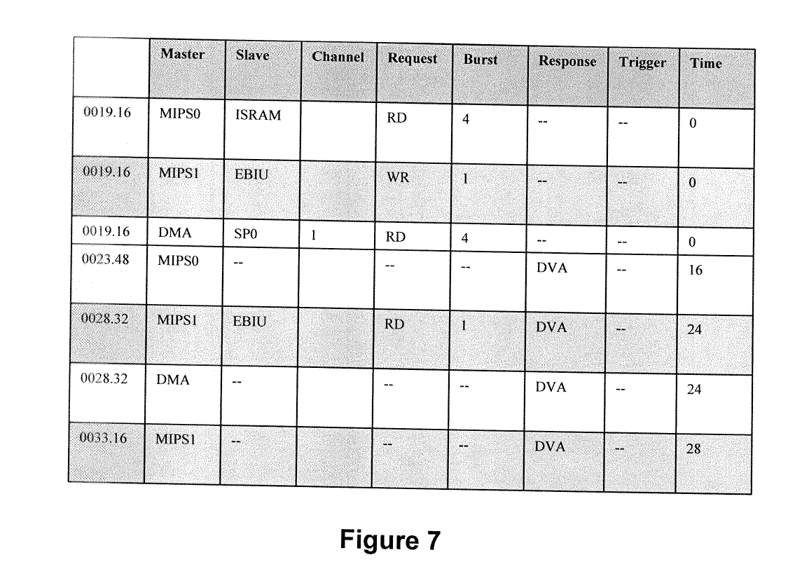

Various techniques associated with the bus transaction constructor 130 may be used to simplify the interpretation of the raw data. For example, graphical indicia may be used to distinguish the activity of each master device. In the example of FIG. 7, grayscale shading is used to highlight the activity associated with the master device identified as processor MIPS 1.

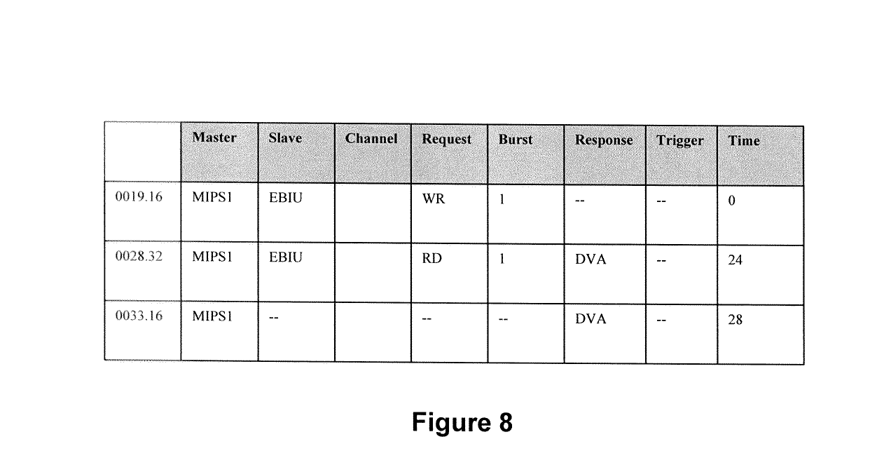

Alternately, the bus transaction constructor 130 may filter the raw data and only present data characterizing a subset of bus activity. For example, FIG. 8 illustrates filtered bus activity data that only reflects the data associated with the master device identified as processor MIPS1. The data illustrated in FIG. 8 corresponds to the shaded data of FIG. 7, but does not include the other data associated with FIG. 7.

A transaction mode shows requests occurring in each clock cycle and associated responses in the display. In the transaction mode, the display also shows a cycle duration which is the time between the request and its associated response, computed by subtracting the timestamps of the request and response messages.

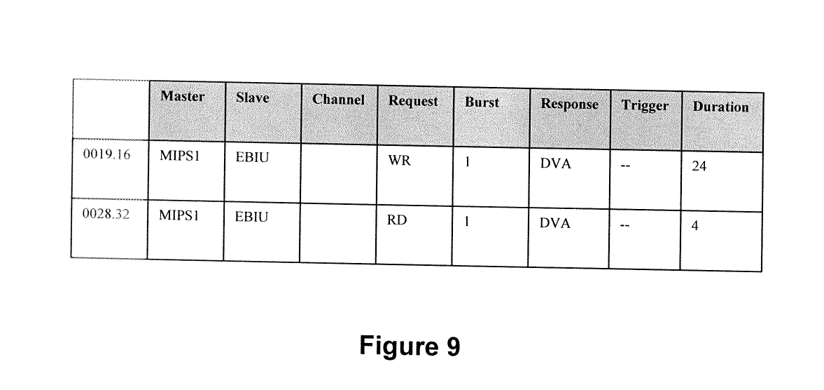

In FIG. 9, request and response transaction information is combined. The timing information in this example is in the form of a time measure associated with the duration of the transaction. The first row of data in FIG. 9 corresponds to the information in the second and fifth rows of data in the raw data of FIG. 6. As shown in FIG. 6, the time between these transactions is (24-0) 24, which is the duration value reflected in the first row of FIG. 9.

The second row of data in FIG. 9 corresponds to the information in the fifth and seventh rows of data in the raw data of FIG. 6. The time difference between these transactions (28-24) is reflected as the duration (4) shown in the second row of FIG. 9.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A method, comprising:
monitoring bus transactions between masters and slaves;
generating simplified bus transaction descriptors to characterize the bus transactions;
consolidating the simplified bus transaction descriptors to form a bus transaction trace stream;
routing the bus transaction trace stream to a probe.

2. The method of claim 1 further comprising uploading the bus transaction trace stream from the probe to a computer.

3. The method of claim 1 further comprising reconstructing bus activity based upon the bus transaction trace stream.

4. The method of claim 3 further comprising characterizing the bus activity with bus activity data.

5. The method of claim 4 wherein the bus activity data includes two or more of: master identification, slave identification, channel identification, request type, burst length, response type, trigger information, and timing information.

6. The method of claim 4 wherein the bus activity data includes raw, unfiltered data.

7. The method of claim 4 wherein the bus activity data includes graphical indicia for distinguishing the activity of each master.

8. The method of claim 4 wherein the bus activity data includes filtered data characterizing a subset of bus activity.

9. A system, comprising:
a bus;
bus agents connected to the bus, each bus agent generating simplified bus transaction descriptors characterizing bus traffic; and
a funnel to consolidate the simplified bus transaction descriptors from the bus agents to form a bus transaction trace stream.

10. The system of claim 9 further comprising:
master devices connected to the bus;
slave devices connected to the bus; and
a switch connected to the bus to route traffic between the master devices and the slave devices.

11. The system of claim 9 wherein each bus agent compresses bus transaction information to form simplified bus transaction descriptors in a common format.

12. The system of claim 9 wherein the bus agents generate information to facilitate subsequent reconstruction of bus activity.

13. The system of claim 9 wherein the funnel includes a configurable multiplexer.

14. The system of claim 13 further comprising a register to store a configuration value for the configurable multiplexer.

15. The system of claim 9 wherein the funnel is configured to support communication with a probe.

16. The system of claim 9 wherein the master devices are selected from multi-purpose processors, digital signal processors, audio processors, video computation elements, and direct memory access controllers.

17. The system of claim 9 wherein the slave devices are selected from memory blocks and peripherals.

18. The system of claim 9 wherein the simplified bus transaction descriptors include request address information, transaction type, and burst information.

19. The system of claim 18 wherein the request address information includes a slave identification and an offset.

20. The system of claim 9 wherein the simplified bus transaction descriptors include read data transfer information and identification request information.

21. The system of claim 9 wherein the bus transaction trace stream includes a slave identification, a burst length, a request phase transaction identification and a response phase transaction identification.

22. The system of claim 9 in combination with a probe, wherein the probe time stamps the bus transaction trace stream.

23. The system of claim 22 in further combination with a computer to reconstruct bus traffic based upon the bus transaction trace stream.

24. The system of claim 23 further comprising computer code executed by the computer to display a time associated with a bus transaction.

25. The system of claim 23 further comprising computer code executed by the computer to display a time differential between two bus transactions.

26. A computer readable storage medium, comprising executable instructions to characterize:
a bus;
bus agents connected to the bus, each bus agent generating simplified bus transaction descriptors characterizing bus traffic; and
a funnel to consolidate the simplified bus transaction descriptors from the bus agents to form a bus transaction trace stream.

27. The computer readable storage medium of claim 26 further comprising executable instructions to characterize:
master devices connected to the bus;
slave devices connected to the bus; and
a switch connected to the bus to route traffic between the master devices and the slave devices.
